(19) United States
(12) Patent Application Publication
(10) Pub. No.: US 2022/0347041 A1
(43) Pub. Date: Nov. 3, 2022

(54) MOTORISED WALKER AND ASSOCIATED CONTROL METHOD

(71) Applicant: GEMA, Ivry-Sur-Seine (FR)

(72) Inventors: Viviane PASQUI, Viroflay (FR); Pascal MARTINELLI, Sceaux (FR)

(21) Appl. No.: 17/760,986

(22) PCT Filed: Sep. 18, 2020
(86) PCT No.: PCT/FR2020/051631

§ 371 Date: Apr. 25, 2022

(30) Foreign Application Priority Data
Sep. 18, 2019 (FR) 1910307

(51) Int. Cl. A61H 3/04

(52) U.S. Cl. CPC A61H 3/04; A61H 2003/043

(57) ABSTRACT

The invention relates to a motorized walker (1) comprising a frame (10) having a front portion (10a) and a rear portion (10b), a pair of wheels (11), with one wheel arranged to support the front portion of the frame, one of the wheels being coupled to a traveling motor (20), said motorized walker (1) being characterized in that:
the frame (10) is equipped with two verticalization ramps (100) having a longitudinal axis forming an angle with an axis perpendicular to the ground, between 20° and 40°, each being associated with an electronic handle (200) movable in translation,
it comprises at least one verticalization motor (30) arranged to allow movement of the electronic handles (200), and
at least one of the electronic handles (200) comprises one or more sensors coupled to a control module (40) configured to control the verticalization motor (30) and the traveling motor (20).

The invention relates to the field of walking aids, and more particularly to motorized walkers. The invention relates to a method for controlling a motorized walker for generating autonomy for its user.

### PRIOR ART

Many people suffer from walking and balance disorders. These disorders have various origins and can affect people of all ages, but are common in the context of physiological aging. However, the world's aging population is growing rapidly, and the percentage of elderly people is expected to increase from 10% in 2000 to 24% by 2030 (Shishehgar et al. A systematic review of research into how robotic technology can help older people. Smart Health. Volumes 7-8, June 2018, Pages 1-18). The need for care of the elderly will therefore increase, even though it is already high, particularly in countries such as Japan, the United States, Canada, Australia and in Europe.

Taking care of a person with walking and balance problems is based on three aspects: rehabilitation, adjustment of the living environment and the use of technical aids. Examples of technical walking aids are: canes, walking frames, and walkers. Technical aids for walking allow a person with walking and/or balance problems to regain some independence. Some walking frames are designed to be used from the sitting position and allow support during sit-to-stand transfers, but are difficult to use when walking (3-step walking: the person, leaning on the walking frame, moves one foot forward, then the other foot, then, still leaning on his/her feet, the person moves the walking frame forward). These walking frames are stable but inert supports, that is to say they do not actively assist the person in his/her movements. The most user-friendly walking aids have wheels and cannot be used for support during sit-to-stand and stand-to-sit transfers due to lack of stability. For example, a motorized walker with lower and upper handles that can facilitate the user's transition from sitting to standing has been proposed (U.S. Ser. No. 10/292,891). Sit-to-stand and stand-to-sit assistance is then provided by a third party, such as staff in residential homes for the elderly or in hospitals. These repeated manipulations are responsible for musculoskeletal disorders of the caregivers. This situation has contributed to the emergence of “caregiver aids”, which have been very successful in hospitals and EHPAD. These include mechanical or electrical sit-to-stand devices, marketed with the aim of preventing musculoskeletal disorders (MSDs) among caregivers. The use of technical aids such as a sit-to-stand device considerably reduces work stoppages by avoiding musculoskeletal disorders. Nevertheless, this type of caregiver aid requires the use of a second device in addition to the walking assistance apparatus. This poses difficulties in handling, storage, caregiver attendance and cost. It has also been proposed by the applicant a removable sit-to-stand aid device arranged to be positioned on a walker and comprising a telescopic structural rod allowing to make the device universal (FR3073393). However, such a device is not a walker and, as a sit-to-stand device designed for standing up, it does not facilitate the movement of an individual using a walker. In addition, being able to adapt to multiple walkers limits the ability to precisely control the sit-to-stand angle. However, such a sit-to-stand angle has a critical impact on the transition from a sitting position to a standing position.

It has been proposed in the literature that apparatus or technical aids for walking are capable of lifting a user from a seated state, for example in a wheelchair, to a standing state (U.S. Pat. No. 7,938,756). However, this type of apparatus is generally intended for people who have lost all motor skills in their lower limbs and, apart from lifting the user, they do not allow to help him/her in his/her movement. They are often used as a substitute for the user.

There is therefore a need for a walking assistance apparatus capable of facilitating, on the one hand, the users transition from a sitting to a standing position, and on the other hand, his/her movement.

### Technical Problem

The invention therefore aims to overcome the disadvantages of the prior art. In particular, the invention aims to provide a motorized walker arranged to assist the user in moving from a seated to a standing position while providing control means configured to control the movement of the walker in an intuitive manner.

The invention further aims to provide a method for controlling a motorized walker, said method adapting to the users movement and not requiring said user to perform complex movements.

### Brief Description of the Invention

To this end, the invention relates to a motorized walker comprising a frame having a front portion and a rear portion, a pair of wheels being arranged to support the rear portion of the frame, and at least one wheel being arranged to support the front portion of the frame, at least one of the wheels being coupled to a traveling motor, said motorized walker being characterized in that:
the frame is equipped with two verticalization ramps, said verticalization ramps having a longitudinal axis forming an angle with an axis perpendicular to the ground, between 20° and 40°, each of said verticalization ramps being associated with an electronic handle movable in translation along the verticalization ramp to which it is associated,
it comprises at least one verticalization motor arranged to allow a movement, preferably a synchronous movement, of the electronic handles along the verticalization ramps, preferably said displacement being capable of moving a user of the walker from a sitting position to a standing position, and
at least one of the electronic handles comprising one or more sensors operatively coupled to a control module, said control module being configured to be able to control the verticalization motor and the traveling motor.

Thus, such a walker motorized by its electronic handles and its joint control of the verticalization and traveling motors makes it possible to provide autonomy to its user. Indeed, unlike the walkers of the prior art which can only help a user to stand up or to move around, the arrangement and configuration of the motorized walker according to the invention allow a user to no longer have to depend on a third person for most of his/her movements.

According to other optional features of the motorized walker, the latter may optionally include one or more of the following features, alone or in combination:
the control module is configured to calculate an index corresponding to an intention of a user of the walker, for example whether he/she wishes to stand up or sit down, said index being calculated from data generated by the one or more sensors of the electronic handles.
the calculation of the index corresponding to the intention of a user of the walker further uses a prediction model trained from data generated, by the one or more sensors of the electronic handles, during the use of the motorized walker by said user.
the control module is configured to further determine whether a user of the walker is standing while leaning on the walker from data generated by the one or more sensors of the electronic handles. The control module may be configured to further determine when a user of the walker is seated and the user is not leaning on the walker, in particular from a prediction model trained from data generated, by the one or more sensors of the electronic handles, during the use of the motorized walker by said user.
each of the verticalization ramps comprises a motorized screw-nut system driven by the verticalization motor allowing the electronic handles to move along the verticalization ramps. Many systems for transmitting a rotational motion of the motor to a translational motion of the handle would be suitable. Nevertheless, the screw-nut system integrates very well into the verticalization ramps.
the electronic handles and the verticalization ramps are coupled via an internal guide system. Such a guide system allows to improve the sturdiness of the walker and the comfort of the user when raising a handle in its verticalization ramp.
the verticalization ramps have a bearing located opposite the verticalization motor in relation to the screw. Such a bearing allows both to guide the screw in the tube and to absorb the axial forces induced by the user.
the electronic handles and the verticalization ramps are coupled via an external guide system. It allows to absorb a part of the efforts induced by the user, in particular during the verticalization of the user.
it has two verticalization motors, each coupled to one of the verticalization ramps and preferably positioned at one end of the verticalization ramp.
it comprises a data memory, said data memory being configured to store a maximum height of the handles on each of the verticalization ramps, said maximum height of the electronic handles having been calculated from a prediction model and data generated by the one or more sensors of the electronic handles. The maximum height can also correspond to a value predetermined during the first configuration of the walker and then it is corrected by learning as the user uses the walker. In addition, other values can be set during the first use and then automated with learning, such as the speed of verticalization and more particularly the kinetics of verticalization or the force thresholds for initiating verticalization.
it comprises a data memory, said data memory being configured to store a minimum height and a maximum height of the electronic handles on each of the verticalization ramps. Thus, the motorized walker according to the invention can be specifically adapted to its user for a better comfort of use.
it comprises a human-machine interface configured to detect the users intention (to stand up or sit down) and whether the user is still in connection with the sit-to-stand device (if for example there was a false start, and the user did not stand up). In particular, such an interface can be integrated into the one or more electronic handles in the form of sensor(s).
the sensor is selected from: a force sensor, a pressure sensor, a photoelectric barrier cell, a displacement sensor.
the control module is configured to further calculate a force variation value applied to the electronic handle over a time interval and to initiate movement of the electronic handles when the calculated applied force variation value is greater than a predetermined force variation value. Thus, the motorized walker can carry out a verticalization adapted to the individual at a time wished by the individual without him/her having to carry out another action than to lean on the electronic handles when he/she wishes to stand up by leaning on a table, for example.
the control module is configured to further calculate a force value applied to the electronic handle and to initiate verticalization only if the calculated force value applied to the electronic handle at the beginning of a time interval is lower than or equal to a predetermined force value.
it comprises a proximity sensor, preferably configured to measure a proximity value between the trunk of a user of the walker and the frame, and the control module is further configured to initiate verticalization when the measured proximity value is greater than a predetermined proximity value.
the control module is further configured to control at least one verticalization motor so as to minimize jerk (Anglo-Saxon terminology) during ascent, and preferably to control the position of the electronic handles during ascent so that their position X(t) satisfies the following equation:

$$X ( t ) = {X}_{i} + ( {X}_{f} - {X}_{i} ) ⋆ [ 10 ⋆ {( \frac{t}{T} )}^{3} - 15 ⋆ {( \frac{t}{T} )}^{4} + 6 ⋆ {( \frac{t}{T} )}^{5} ]$$

(Hogan N (1984) Adaptive control of mechanical impedance by coactivation of antagonist muscles. IEEE Trans. Automatic. Control AC-29: 681-690)

Where:
X(t) is the position of the electronic handle, on a vertical axis, with respect to a lowest position Xi, as a function of time t;
Xf is a maximum height of the electronic handle, and
T is a total verticalization time.

The central nervous system moves the hand or another end effector smoothly from one point to another during a movement. To do this, it minimizes ‘jerk’ (Anglo-Saxon terminology), that is to say the variation of the force along a trajectory. Thus, the handles follow a trajectory that is most adapted to human movement and therefore more comfortable.

The invention further relates to a method for controlling a motorized walker according to the invention, said control method comprising the following steps:
Measuring, by a sensor of at least one electronic handle, at least one force value applied to the electronic handle,
Comparing, by a control module, the at least one force value applied to a predetermined threshold value of an applied force, and
Generating, by the control module, a control command to at least one of the verticalization and traveling motors according to the determined position of the at least one electronic handle and the measured applied force value.

Thus, such a control method allows, from a measurement of a force value applied to an electronic handle, to generate a control instruction for one of the verticalization motors and one of the traveling motors. Thus, in one measurement step, the method can determine a users intent and control the walker's motors to facilitate it.

Other implementations of this aspect include computer systems, apparatus and corresponding computer programs recorded on one or more computer storage devices, each configured to perform the actions of a method according to the invention. In particular, a system of one or more computers may be configured to perform particular operations or actions, especially a method according to the invention, by installing software, firmware, hardware or a combination of software, firmware or hardware installed on the system. In addition, one or more computer programs may be configured to perform particular operations or actions by means of instructions which, when executed by data processing equipment, cause the equipment to perform the actions.

Other advantages and features of the invention will appear upon reading the following description given by way of illustrative and non-limiting example, with reference to the appended figures:

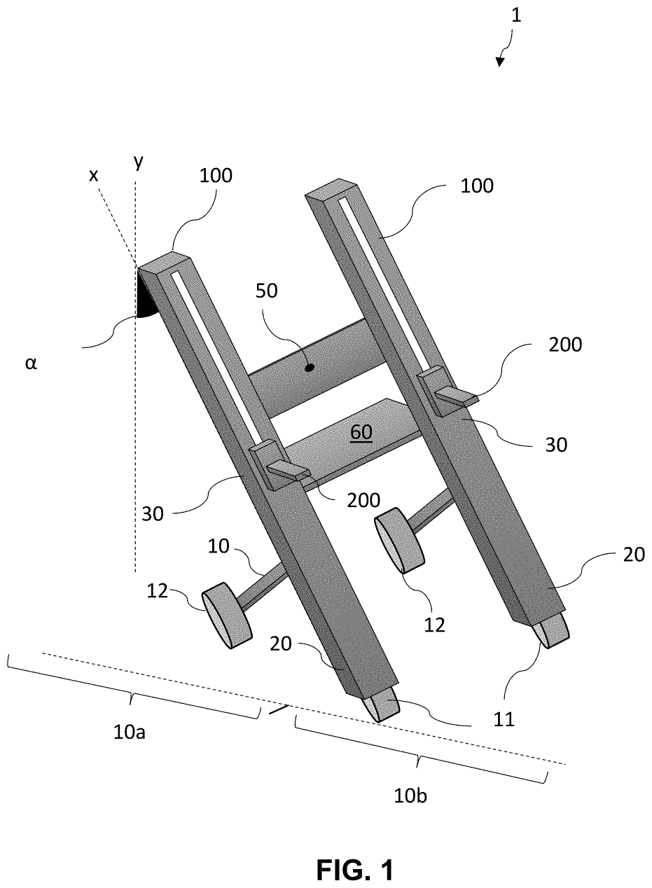

FIG. 1 is an illustration of a perspective view of a motorized walker according to one embodiment of the invention.

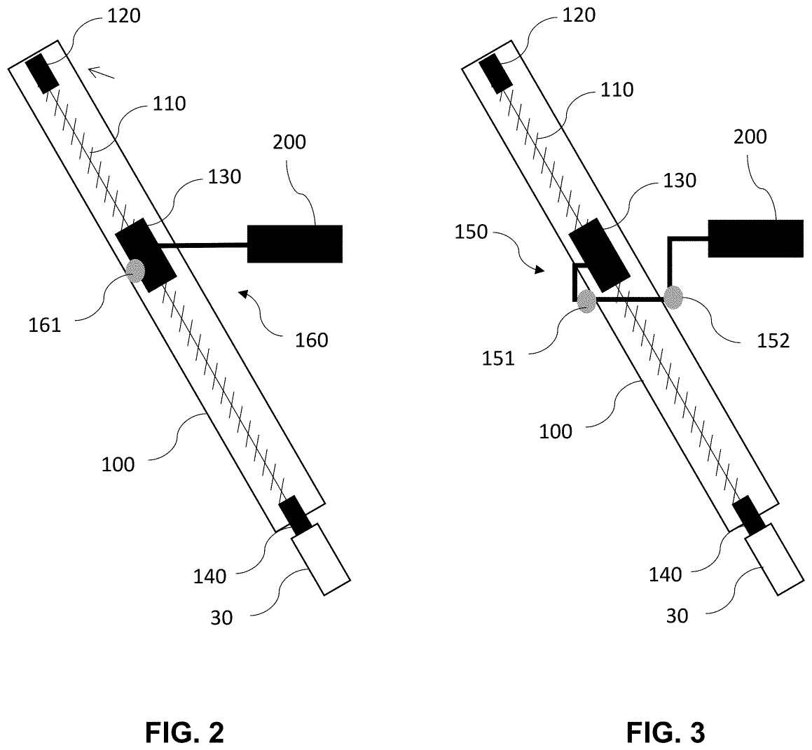

FIG. 2 is an illustration of a side view of a longitudinal section of a verticalization ramp according to one embodiment of the invention.

FIG. 3 is an illustration of a side view of a longitudinal section of a verticalization ramp according to one embodiment of the invention.

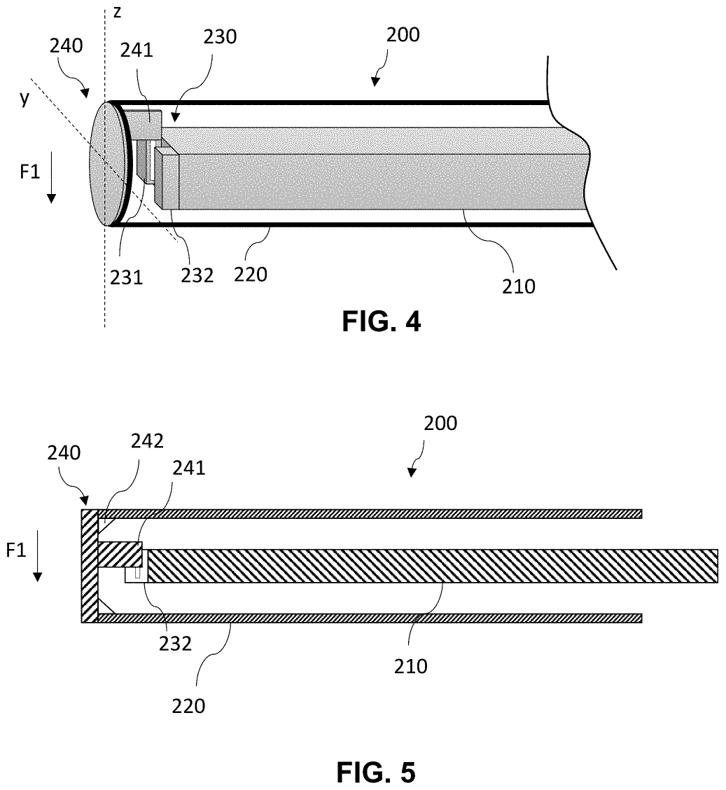

FIG. 4 is an illustration of a perspective view of an electronic handle according to one embodiment of the invention. Where the outer jacket is shown in transparency to allow visualization of the inside of the handle.

FIG. 5 is an illustration of a side view of a longitudinal section along a z-axis of a handle according to one embodiment of the invention.

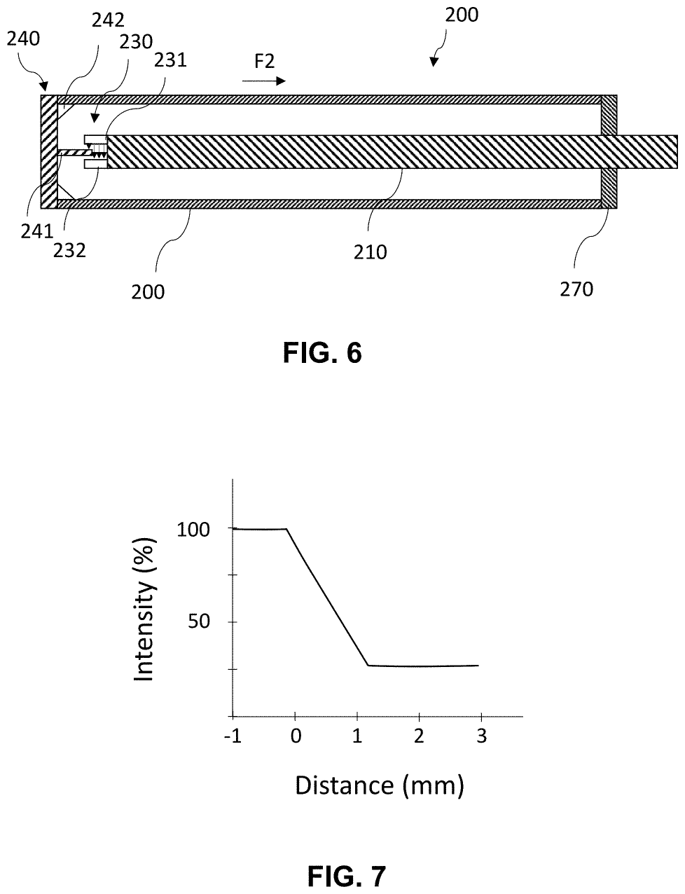

FIG. 6 is an illustration of a top view of a longitudinal section along a y-axis of a handle according to one embodiment of the invention.

FIG. 7 is a curve of light intensity received by the receiver of a photoelectric cell as a function of the displacement of a shutter element.

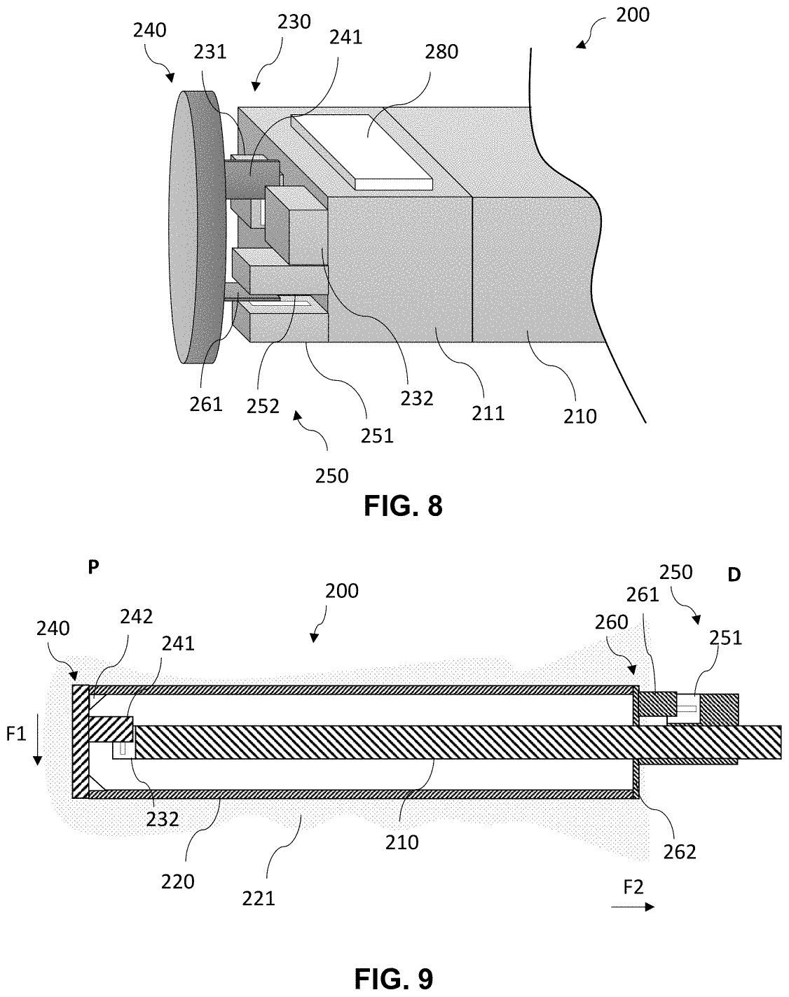

FIG. 8 is an illustration of a perspective view of a handle according to one embodiment of the invention. The outer jacket has been omitted.

FIG. 9 is an illustration of a side view of a longitudinal section along a z-axis of a handle according to one embodiment of the invention.

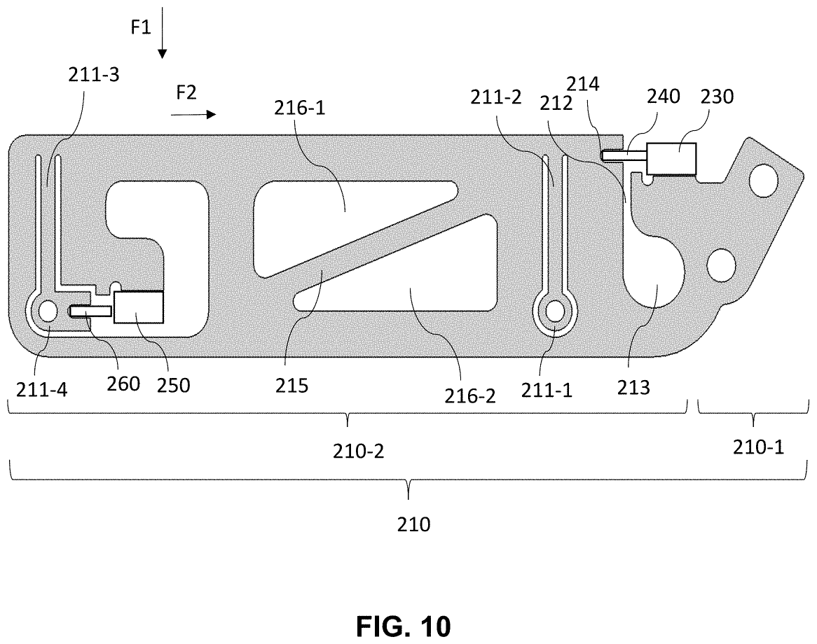

FIG. 10 is an illustration of a front view of the central part of a handle according to the invention.

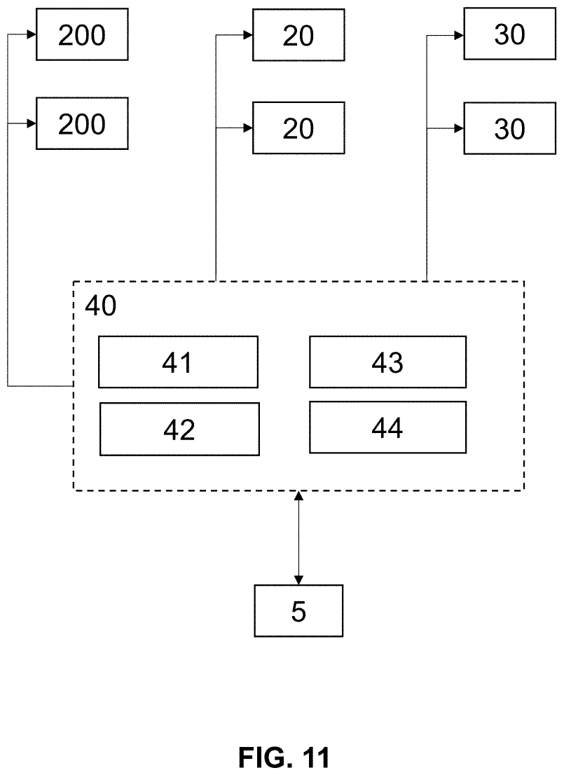

FIG. 11 is a functional diagram of the motors and control members of a motorized walker according to one embodiment of the invention.

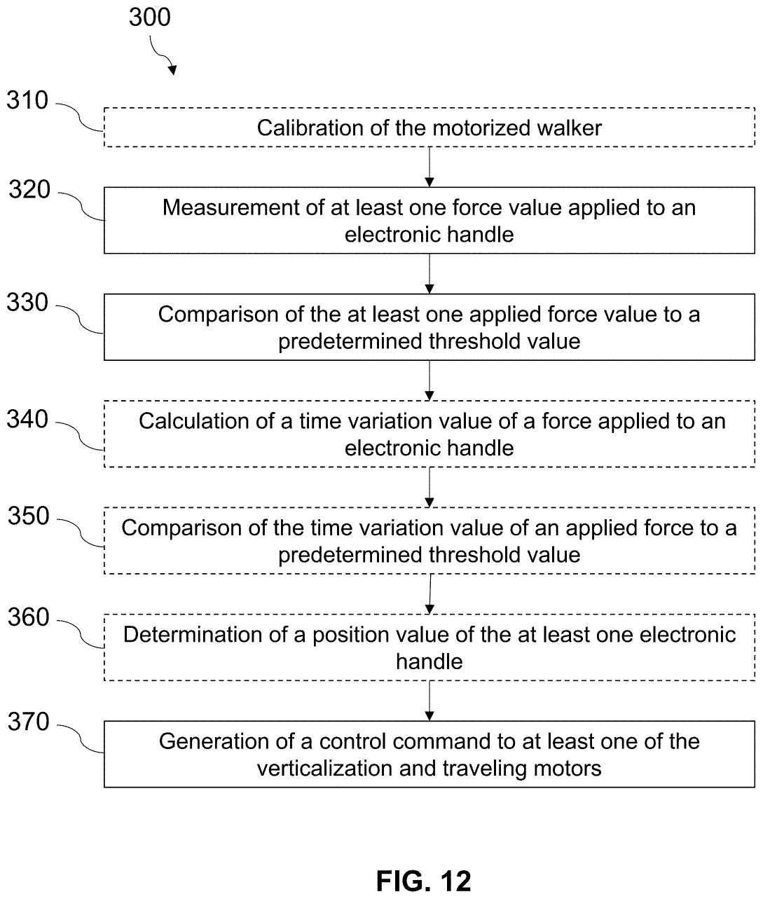

FIG. 12 is an illustrative diagram of a method according to one embodiment of the invention. The steps in dotted boxes are optional.

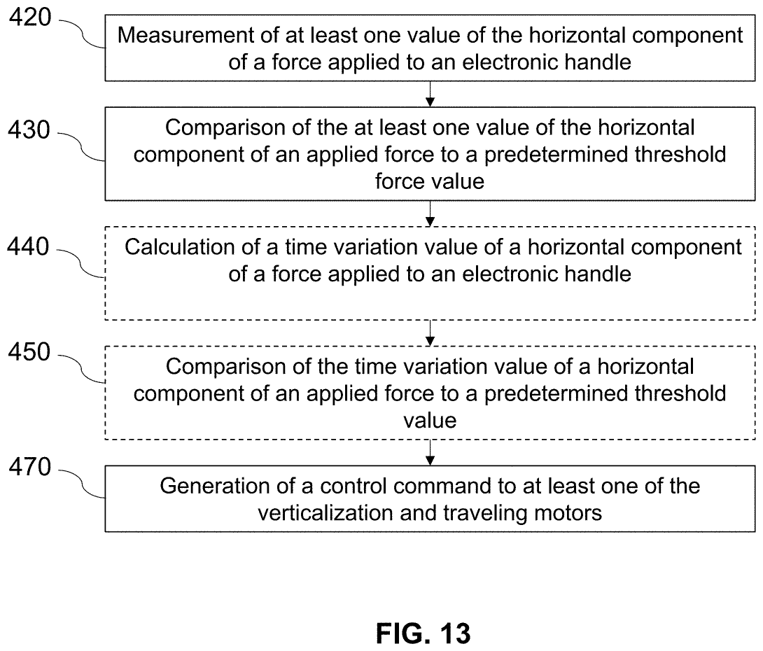

FIG. 13 is an illustrative diagram of the steps of a method according to one embodiment of the invention.

Aspects of the present invention shall be described with reference to flowcharts and/or block diagrams of methods or apparatus (systems) according to embodiments of the invention.

In the figures, the flowcharts and block diagrams illustrate the architecture, functionality, and operation of possible implementations of systems and methods according to various embodiments of the present invention. In this respect, each block in the flowcharts or block diagrams may show a system, device, module, or code, which comprises one or more executable instructions for implementing the one or more specified logical functions.

### Description of the Invention

In the following description, the expressions “front portion” and “rear portion” may be defined as all the elements of the motorized walker located on either side of a longitudinal sectional plane of a front view of the motorized walker, respectively, said longitudinal sectional plane passing through the center of gravity of said motorized walker. With the rear portion being the one intended to accommodate a user.

The expression “axis perpendicular to the ground”, and represented by the y-axis in the figures, corresponds to an axis forming an angle substantially equal to 90° with any surface in contact with the wheels of the motorized walker.

In the following description, the expression “electronic handle” corresponds, for example, to a device for supporting the weight of a user, arranged to accommodate a hand of said user and comprising within it one or more sensors arranged to allow a measurement of a force.

The term “force”, within the meaning of the invention, corresponds to a mechanical action exerted by a user on a surface and in particular on the electronic handle. Thus, an “applied force”, within the meaning of the invention, corresponds to a user exerting pressure on the outer surface of said electronic handle.

The expression “component of a force” corresponds to a projection of a force on a direction. A “first component” thus corresponds, for example, to a projection of a force along an axis Z, represented by an axis orthogonal to the longitudinal axis of the electronic handle. A “second component” thus corresponds to a projection of a force along an axis X, corresponding to the longitudinal axis of the electronic handle.

The term “attached” corresponds to securing two distinct entities one to the other. Thus, two entities may have a removable or non-removable attachment.

The term “removable” corresponds, according to the invention, to the ability to be detached, removed, or disassembled easily without having to destroy the means of attachment either because there is no means of attachment or because the means of attachment can be easily and quickly disassembled (for example notch, screw, tongue, lug, clips). For example, by removable, is to be understood that the object is not attached by welding, or any other means not intended to allow the object to be detached.

A “non-removable” or “irremovable” attachment according to the invention corresponds to the ability not to be detached, removed, or disassembled without having to destroy means of attachment either because there is no attachment means or because the attachment means are not easily and quickly removable. For example, by non-removable, it should be understood that the object is attached by welding or more generally by any means of irreversible securing.

The term “tubular” corresponds to a substantially elongated member forming a conduit, the lumen of which is enclosed by a wall of said conduit. Such a lumen thus refers to a hollow interior space circumscribed by the duct wall.

When the term “substantially” is associated with a particular value, the latter is to be understood as a value varying by less than 30% with respect to the compared value, preferably by less than 20%, even more preferably by less than 10%. When substantially identical is used to compare shapes, then the vectorized shape varies by less than 30% with respect to the compared vectorized shape, preferably by less than 20%, even more preferably by less than 10%.

By “polymer” is meant either a copolymer or a homopolymer. A “copolymer” is a polymer with several different monomer units and a “homopolymer” is a polymer with identical monomer units. A polymer can for example be a thermoplastic or thermosetting polymer.

By “thermoplastic polymer” or “thermoplastic” is meant a polymer that can be repeatedly softened or melted by the action of heat and that adopts new shapes by the application of heat and pressure. Examples of thermoplastics are: high-density polyethylene (HDPE), polyethylene terephthalate (PET), polyvinyl chloride (PVC), polystyrene (PS), or acrylonitrile butadiene styrene (ABS).

By “thermosetting polymer” is meant a plastic material that is irreversibly transformed by polymerization into an insoluble polymer network. Once the shape of the thermosetting polymer is set and cooled, it cannot be changed by heat. Thermosetting polymers are, for example: unsaturated polyesters, polyimides, polyurethanes, or vinyl esters which can be epoxy or phenolic.

By “coupled” is meant, within the meaning of the invention, connected, directly or indirectly, with one or more intermediate elements. Two elements may be coupled mechanically, electrically, or linked by a communication channel.

By “process”, “calculate”, “run”, “determine”, “display”, “extract”, “compare” or more broadly an “executable operation” is meant, within the meaning of the invention, an action performed by a device or a processor unless the context indicates otherwise. In this respect, operations refer to actions and/or processes in a data processing system, such as a computer system or electronic computing device, which manipulates and transforms data represented as physical (electronic) quantities in the memories of the computer system or other devices for storing, transmitting, or displaying information. These operations may be based on applications or software.

The terms or expressions “application”, “software”, “program code”, and “executable code” mean any expression, code, or notation, of a set of instructions intended to cause a data processing to perform a particular function directly or indirectly (for example after a conversion operation into another code). Exemplary program codes may include, but are not limited to, a subprogram, a function, an executable application, a source code, an object code, a library, and/or any other sequence of instructions designed for being performed on a computer system.

Within the meaning of the invention, the term “processor” refers to at least one hardware circuit configured to execute instructions contained in the program code. The hardware circuit may be an integrated circuit. Examples of a processor include, but are not limited to, a central processing unit (CPU), a network processor, a vector processor, a digital signal processor (DSP), a field-programmable gate array (FPGA), a programmable logic assembly (PLA), an application-specific integrated circuit (ASIC), a programmable logic circuit, and a controller.

The term “learning”, within the meaning of the invention, corresponds to a method designed to define a function f allowing a value Y to be calculated from a base of n labeled (X1 . . . n, Y1 . . . n) or unlabeled (X1 . . . n) observations. Such a function can correspond to a prediction model. Learning can be said to be supervised when it is based on labeled observations and unsupervised when it is based on unlabeled observations. In the context of the present invention, learning is advantageously used for customizing the operation of the walker and thus adapting it to a particular user.

By “prediction model” is meant any mathematical model for analyzing a volume of data and establishing relationships between factors for assessing risks or opportunities associated with a specific set of conditions, in order to guide decision-making towards a specific action.

The expression “human-machine interface”, within the meaning of the invention, corresponds to any element allowing a human being to communicate with an electronic device.

By “motorized” is meant, within the meaning of the invention, an apparatus or a device equipped with any known suitable means (for example a motor) allowing to generate a displacement of all or part of the device with which said means is associated.

In the following description, the same references are used to designate the same elements. Walking aids such as motorized walkers do not generally allow for smooth assistance in verticalization (moving from a sitting to a standing position) of the user and then for smooth assistance in moving. Indeed, the verticalization means are generally absent or provided by complementary devices of assistance to the caregivers.

The present invention proposes to overcome this by detailing a motorized walker having electronic handles arranged to allow for verticalization of the user and capable of controlling the movement of the walker according to the users instructions.

Thus, according to a first aspect, the invention relates to a motorized walker 1. In particular, and as illustrated in FIG. 1, such a motorized walker 1 comprises a frame 10 having a front portion 10a and a rear portion 10b.

The frame 10 may be made of metal, a metal alloy, polymer, a composite assembly, or a mixture of these materials. Preferably, the frame 10 is made of stainless steel. In addition, the frame 10 can be covered with a casing. Such a casing can be made of polymers, composites or any other materials.

A motorized walker 1 according to the invention includes a pair of wheels 11 arranged to support the rear portion 10b of the frame 10, and at least one wheel 12 which is arranged to support the front portion 10a of the frame. As shown in FIG. 1, the frame preferably has two wheels at the rear and two wheels at the front.

Preferably, the motorized walker 1 will have motorized wheels arranged to support the rear portion 10b of the frame 10. For example, the only motorized wheels may be those supporting the rear portion 10b of the frame 10.

Indeed, the walker 1 according to the invention is a motorized walker. Thus, at least one of these wheels is coupled to a traveling motor 20. Such a traveling motor 20 is arranged at one wheel and is not directly visible in FIG. 1. It is hidden by a casing positioned at the one or more wheels. Any type of electric motor can be used, preferably a brushless motor such as an electronically commutated brushless motor.

A motorized walker 1 according to the invention may further comprise a proximity sensor 50. Such a proximity sensor 50 is preferably configured to measure a proximity value between the trunk of a user of the motorized walker 1 and the proximity sensor 50. Since the proximity sensor 50 is generally attached to the frame 10 or to a frame element, this allows a proximity value to be measured between the trunk of a user of the motorized walker 1 and the frame 10. A motorized walker 1 according to the invention may further comprise a tray 60. Such a tray 60 is generally arranged to be able to support the weight of everyday convenience items, but it can preferably be arranged to be able to support the weight of a given user. Thus, a motorized walker 1 according to the invention may include a tray 60 attached to the frame and/or the verticalization ramps.

Furthermore, advantageously, the frame 10 of the motorized walker 1 according to the invention is equipped with two verticalization ramps 100. Preferably, both verticalization ramps are non-removably attached to the frame 10. Nevertheless, they can alternatively be attached to the frame 10 in a removable way.

Advantageously, these verticalization ramps 100 have a longitudinal axis (noted “x” in connection with FIG. 1) forming an angle (noted “a” in connection with FIG. 1) with an axis perpendicular to the ground (noted “y” in connection with FIG. 1) between 20° and 40°. Preferably, these verticalization ramps 100 have a longitudinal axis forming an angle with an axis perpendicular to the ground of between 25° and 35°, more preferably substantially equal to 30°, and even more preferably equal to 30°. Indeed, it has been determined in the context of the present invention that such an inclination allows for efficient verticalization of a subject and results in the least instability of the subject during verticalization.

In addition, each of these verticalization ramps 100 is associated with an electronic handle 200 movable in translation along the verticalization ramp 100 with which it is associated.

As mentioned, the electronic handles 200 are arranged to be able to move a user from a seated position to a standing position, that is to say to experience verticalization. To enable such verticalization, the motorized walker 1 also includes at least one verticalization motor 30. The at least one verticalization motor 30 is preferably arranged to control a movement of the electronic handles 200 along the verticalization ramps 100. For example, a single motor could be enough, it would simultaneously activate both handles coupled thereto through a torque transmission means. Any type of electric motor can be used, preferably a brushless motor such as an electronically commutated brushless motor. In particular, each of the verticalization ramps 100 may include a verticalization motor 30.

Thus, the walker advantageously comprises two verticalization motors 30, each coupled to one of the verticalization ramps 100.

As shown in FIGS. 2 and 3, the motors are preferably positioned at one end of the verticalization ramp 100. In this case, the motors are positioned at the lower end of each of the verticalization ramps 100. Indeed, since the loading forces on the handle are directed downwards, it is easier to position the motor at the bottom because recovering the forces can then be done at the upper bearing, which stresses the screw in traction. There is therefore no risk of the screw buckling. In addition, the position of the motor at the bottom allows the height of the apparatus to be reduced.

Advantageously, each of the verticalization ramps 100 comprises a transmission system which, driven by the verticalization motor 30, allows the electronic handles 200 to move along the verticalization ramps 100.

Moving the electronic handles 200 along the verticalization ramps 100 is advantageously suitable for moving the walker's user from a seated position to a standing position. Thus, the movement of the electronic handles 200 is preferably a synchronized movement so as not to cause the user to lose balance.

The transmission system may be any means arranged to transmit a rotational movement (verticalization motor 30) into a translational movement (electronic handle 200). For example, it can be selected from the following systems: rack, crank, cam, belt, screw-nut. When the motorized walker 1 has only one verticalization motor 30, then the transmission system is arranged so as to allow translational movement of both electronic handles 200.

Preferably, each of the verticalization ramps has a motorized screw-nut system driven by the verticalization motor 30. Such a system includes a screw 110 extending from the verticalization motor 30 to a guide device 120 and a nut 130 adapted to be moved along the screw 110.

Preferably, the verticalization ramps 100 have a guide device 120 located opposite the verticalization motor with respect to the screw. Such a guide device 120 allows both to guide the screw 110 but also to absorb part of the axial forces induced by the user. Indeed, a screw 110 that can be used has a length value that is much higher than the diameter value and has to withstand large axial forces transmitted by the handles. Thus, it should preferably be guided at both ends. Thus, advantageously, in order to guide the screw and hold it on a predefined axis, the screw is placed in a guide device 120 comprising a ball bearing.

Advantageously, the guide device 120 is arranged so as to block the screw 110, in particular to prevent any rotational movement of said screw 110, when the motorized walker 1 is at a standstill. Thus, there is no risk of unintentional lowering of the electronic handles.

The screw 110 can be any type of screw suitable for a screw-nut system. In particular, it can be selected from screws with trapezoidal, square, triangular threads, or ball screw nuts. In particular, the screw 110 can be coupled to the verticalization motor 30 via a sleeve 140 allowing the screw-motor coupling. Such a sleeve 140 is preferably arranged to allow a flexible coupling between the screw 110 and the verticalization motor 30. Such a flexible coupling allows the motor to be isolated from the axial forces of the screw.

The electronic handles 200, coupled with the verticalization ramps 100, must be able to support at least a portion of an individual's weight since one of their functions is to move an individual from a seated position to a standing position. Thus, the electronic handles 200 and the verticalization ramps 100 are arranged to support a weight of at least 30 kilograms, preferably at least 50 kilograms, and most preferably at least 70 kilograms.

In order to reinforce the robustness of a motorized walker 1 according to the invention, two different types of guide are proposed within the framework of the present invention: an internal guide 160, an embodiment of which is illustrated in FIG. 2, and an external guide 150, an embodiment of which is illustrated in FIG. 3.

Thus, in an embodiment shown in FIG. 2, the electronic handles 200 and the verticalization ramps 100 are coupled via an internal guide system 160.

The internal guide system 160 may, for example, include a rail or track within the verticalization ramp 100 over which an element attached to an electronic handle 200 will slide. Alternatively, an element 161 attached to an electronic handle 200 will slide along the inner surface of a verticalization ramp so as to transfer a portion of the efforts experienced by the verticalization handle. Such an element 161 can, for example, correspond to a ball bearing. Preferably, the electronic handles 200 and the verticalization ramps 100 are coupled via an internal guide system, and said internal guide system comprises a rail on which an element attached to the electronic handle 200 slides.

In addition, in an embodiment shown in FIG. 3, the electronic handles 200 and the verticalization ramps 100 are coupled via an external guide system.

For example, the external guide system may include a rail or track on the outside of the verticalization ramp 100 over which an element attached to an electronic handle 200 will slide. In addition, the external guide system may include bearings 151, 152 positioned in contact with a front side and/or a rear side of the verticalization ramp 100.

In addition, the verticalization ramps 100 include at least one end-of-stroke sensor. With such an end-of-stroke sensor or position sensor or limit switch being preferably selected from: an optoelectronic sensor, a barrier photo-transistor, a roller push switch, a roller lever switch, a spring rod, and a magnetic loop rod. As a non-limiting example, a photo-transistor is used as an end-of-stroke sensor and is located at the bottom of a verticalization ramp, for example in a cylinder. It is used to initialize the position of the handle when the device is turned on. Once the original measurements are made, the position of the handle can be known thanks to the hall effect sensors integrated in the motor.

The electronic handles 200 configured to measure a force applied thereto may be equipped with force sensors, torque sensors, pressure sensors, strain gauges, piezoelectric type technology, or simple button sensors.

Advantageously, the electronic handles 200 used in the context of the invention include a coupling between a photoelectric cell and a shutter element. In particular, a photoelectric cell can be a sensor consisting of an infrared transmitter and an opposite receiver. The emission area is therefore a line of infrared light. When a shutter element such as a flag penetrates between the transmitter and the receiver, the amount of light received by the receiver becomes increasingly smaller. The measurement of the current at the output of the sensor is proportional to the amount of light measured and therefore to the penetration distance of the flag. This distance can then be related to the force, applied to the handle, that caused the displacement.

Thus, such an electronic handle allows the control of a walker without the user wearing sensors or operating buttons (or another interface). Such an arrangement makes it possible to detect a force, applied to the handle, greater than or equal to two kilograms, but also much less. In addition, such an arrangement makes it possible to determine a value of an applied force and does not merely detect a threshold being exceeded. Thus, it may be possible for a processor to process information differently depending on the amount of force that has been applied to the electronic handle.

Advantageously, an electronic handle 200 according to the invention is arranged to allow measurement of at least one component of a force applied thereto.

As illustrated in FIG. 4 and FIG. 5, a handle according to the invention includes a central part 210 and an outer jacket 220.

The central part 210 of an electronic handle 200 according to the invention may have a substantially cylindrical shape. Nevertheless, as can be seen in the illustration in FIG. 4, the central part 210 preferably has at least one portion with a section with an edge. For example, it has a polygonal cross-section.

The central part 210 is made of a material preferably having a Young's modulus of at least 60 GPa, for example at least 175 GPa, more preferably greater than 200 GPa. This provides the central part 210 with a rigidity suitable for use in the electronic handle according to the invention. The central part 210 may be made of metal, a metal alloy, polymer, or a composite assembly. Preferably, the central part 210 is made of stainless steel.

The central part 210 preferably has a minimum length of 100 mm or 300 mm and a maximum length of 500 mm.

The outer jacket 220 of an electronic handle 200 according to the invention may have a substantially tubular, preferably tubular, shape. It can have at least one portion with a section with an edge. Nevertheless, preferably, it has an ellipsoidal cross-section and more preferably a circular cross-section.

The outer jacket 220 is made of a material preferably having a Young's modulus of less than 200 GPa, more preferably less than 150 GPa, and even more preferably less than 100 GPa.

Such a constitution and the existence of elasticity in the outer jacket 220 allows for improved performance of the electronic handle according to the invention.

The outer jacket 220 may be made of metal, a metal alloy, polymer, or a composite assembly. Preferably, the outer jacket 220 is made of aluminum.

The outer jacket 220 preferably has a minimum length of 300 mm and a maximum length of 500 mm. In addition, the outer jacket 220 may have an outer diameter between 20 mm and 40 mm and a wall thickness between 1 mm and 3 mm.

Advantageously, the outer jacket 220 is arranged to be capable, under the effect of a force having a vertical component, of translating at least one tenth, preferably one thousandth, of a millimeter with respect to an axis orthogonal to a longitudinal axis of the central part 210. A force component value can be quantified from one tenth, preferably one thousandth, of a millimeter of a displacement.

A displacement of at least one tenth, preferably one thousandth, of a millimeter may preferably correspond to a displacement of at least 0.001 millimeters to 1 millimeter.

In addition, the outer jacket 220 may be arranged to be capable, under the effect of a force having a horizontal component, of translating at least one tenth, preferably at least one thousandth, of a millimeter with respect to a longitudinal axis of the central part 210. A force component value can be quantified from one tenth, preferably one thousandth, of a millimeter of a displacement.

This is possible especially when there is no direct attachment between the outer jacket and the central part. In addition, the presence of joints capable of elastic deformation also allows such translations.

An electronic handle 200 according to the invention includes a first photoelectric cell 230.

Photoelectric cells are electronic devices that typically include a light-emitting diode capable of emitting light pulses, usually in the near infrared range (for example 850 to 950 nm). This light is received or not by a photodiode or a phototransistor depending on the presence or absence of an object on the path of the light pulses. The photoelectric current created can be amplified and then analyzed.

In the context of the invention, a photoelectric cell can be selected from a barrier type photoelectric cell, a reflex type photoelectric cell, and a proximity type photoelectric cell. In addition, it is possible to use optical fibers to change the arrangement of the photoelectric cells within the scope of the invention.

In the context of the invention, a photoelectric cell is preferably a barrier type photoelectric cell for which the barrier is constituted by the shutter element 240.

Such photoelectric sensors can generally be inexpensive but robust compared to commonly used sensors.

The first photoelectric cell 230 includes a first diode 231 capable of emitting a light beam. The diode of a photoelectric cell according to the invention may correspond to an infrared diode.

In addition, the first photoelectric cell 230 includes a first receiver 232 arranged to receive the light beam emitted by the first diode. Preferably, as shown in FIG. 4, the light beam emitted by the first diode is directed directly to the first receiver 232.

The first photoelectric cell 230 is configured to generate a current proportional (of proportional intensity or voltage) to an amount of photons received by the first receiver 232. In particular, it is the first receiver 232 that, as a light transducer, will generate a change in an electric signal in response to the light beam incident on its surface. The first receiver 232 can be, for example, a photoconductor, a photodiode, or a photo transistor.

Preferably, a photoelectric cell according to the invention is configured to generate an electric current, the intensity or voltage of which will be proportional to the amount of photons received by the receiver.

In addition, the electronic handle 200 includes a first shutter element 240 that is capable of altering, or arranged to alter, the amount of photons received by the first receiver 232. In particular, this change in the amount of photons received is a function of the position of the first shutter element 240 with respect to the first photoelectric cell 230.

A shutter member 240, within the meaning of the invention, may be made of metal, a metal alloy, polymer, or a composite assembly. Preferably, the shutter element 240 is made of polymer, most preferably thermoplastic polymer.

The shutter element 240 may include a protrusion 241 arranged to be positioned between the diode 231 and the receiver 232 of the photoelectric cell 230. The protrusion 241 may be removably or non-removably attached to the shutter element 240. Furthermore, in the absence of a protrusion 241, it is the shutter element that accommodates between the diode 231 and the receiver 232.

Importantly, the first photoelectric cell 230 and the first shutter element 240 are at least partially movable relative to each other. Indeed, it is in particular the movement of one with respect to the other, preferably of at least a portion of one with respect to the other, that will allow a measurement of a component of a force applied to the electronic handle 200 according to the present invention.

Thus, according to an embodiment illustrated in FIG. 4 or 5, of the first photoelectric cell 230 and the first shutter element 240, one is attached to the outer jacket 220 and the other is attached to the central part 210. In particular, if one is attached to the outer jacket, it will not be attached to the central part and vice versa. FIG. 5 shows, for example, means for attaching 242 the shutter element 240 to the outer jacket 220. The attachment is preferably a removable attachment.

In particular, the attachment will be made so that a force F1 applied to the electronic handle 200, if sufficient to move the outer jacket 220 at least partially, then it will cause a change in the amount of photons received by the first receiver 232. Furthermore, since the position of the first shutter element 240 allows the amount of photons received by the first receiver 232 to be influenced, then the change in the amount of photons received by the first receiver 232 will be correlated, preferably proportionally, to a first component of the force that was applied to the electronic handle 200.

As illustrated in FIG. 6, the attachment will be made so that a force F2 applied to the electronic handle 200, if sufficient to move the outer jacket 220 at least partially, then it will cause a change in the amount of photons received by the first receiver 232. Furthermore, since the position of the first shutter element 240 allows the amount of photons received by the first receiver 232 to be influenced, then the change in the amount of photons received by the first receiver 232 will be correlated, preferably proportionally, to a second component of the force that was applied to the electronic handle 200. As illustrated, the handle may include an elastically deformable member 270, such as a polymer, so as to allow translation of the outer jacket 220 with respect to the central part 210.

Thus, the electronic handle according to the present invention may include a sensor of a vertical or horizontal force component through a measurement of a displacement of the outer jacket with respect to the central part 210, the displacement being caused by a force having a vertical component or a horizontal component.

In a particular embodiment, the electronic handle 200 has a fixed horizontal shaft, for example made of steel, which can be connected to a walking assistance apparatus (for example a walker) and which serves as a reference. It also includes an outer jacket 220 that can take the form of an outer tube that can translate, under the effect of the horizontal component of the force, by one tenth of a millimeter with respect to the central axis and that, under the effect of the vertical component of the force, deforms in the sagittal plane like an embedded beam. The measurement of this force can be done by a processor for example placed in the electronic handle 200 or in the walking assistance apparatus.

As illustrated in FIG. 7, a photoelectric cell as used in the present invention is preferably configured to be able to generate an electric signal, the intensity or voltage of which is correlated, preferably proportional, to the position of a shutter element. Thus, the change in the amount of photons received by the receiver will be proportional to a component of the force that was applied to the electronic handle 200.

As shown in FIG. 7, the relationship between distance and current is preferably linear over at least 1 mm.

As illustrated in FIG. 8, an electronic handle 200 according to the present invention may also include at least a second photoelectric cell 250.

This second photoelectric cell 250 may share the same characteristics as the first photoelectric cell 230 and in particular its preferred or advantageous characteristics.

Like the first photoelectric cell, the second photoelectric cell 250 includes a second diode 251 capable of emitting a light beam. It also includes a second receiver 252 arranged to receive said light beam.

In addition, the second photoelectric cell 250 is arranged so that a force applied to the electronic handle 200 is able to cause a change in the amount of photons received by the second receiver 252. Generally, the force applied to the electronic handle 200 will be capable of causing a change in the amount of photons received by the second receiver 250 if it is capable of displacing the outer jacket 220 at least partially.

Advantageously, the change in the amount of photons received is proportional to a second component of the force that was applied to the electronic handle 200.

Thus, the presence of a second photoelectric cell 250 allows for better characterization of the force applied to the electronic handle 200.

In addition to the ability to measure a second force component, this allows for the calibration of the electronic handle without manual intervention on the handle and its electronics. In fact, a ‘zero’ is obtained when no force is applied to the system and the measured force can correspond to a percentage of the displacement of the shutter element, for example, with respect to a maximum displacement.

As shown in FIG. 8, the photoelectric cells 230, 250 can be attached indirectly to the central part 210.

In addition, an electronic handle 200 according to the present invention may also include an electronic board 280. Such an electronic board 280 could be configured to measure the output voltage of the photoelectric cell and then transform it into a digital data.

Advantageously, the electronic board 280 is configured to sample the current measurement on 10 bits, which corresponds to 1024 values. Such a sampling allows a resolution of the measurement of the order of a thousandth of a millimeter.

In particular, the electronic board 280 is configured to measure an output voltage or intensity and sample it over at least 4 bits, preferably at least 10 bits.

Considering the correlation between the output voltage or intensity and the displacement in millimeters of the outer jacket 220 with respect to the central part 210, on the one hand, and the correlation between the displacement in millimeters of the outer jacket 220 with respect to the central part 210 and the applied force, on the other hand, the electronic board 280, or an electronic board arranged outside the handle, may be configured to transform the information generated by a photoelectric cell into information on the intensity of the force applied on the electronic handle.

As shown in FIG. 9, an electronic handle 200 according to the present invention may also include a second shutter element 260.

The horizontal and vertical displacement measurements can then be decoupled. A first sensor is used for the deformation of the handle due to a vertical component F1 and a second sensor is used for the horizontal movement of the handle due to a horizontal component F2.

Moreover, the presence of the two sensors allows an automatic calibration (that is to say without manipulation of the sensor).

This second shutter element 260 may share the same characteristics as the first shutter element 240 and in particular its preferred or advantageous characteristics. For example, the second shutter element 260 may include a protrusion 261 arranged to intersect the light beam generated by the second diode 251.

Thus, the second shutter element 260 is capable of changing the amount of photons received by the second receiver 252. This change is in particular a function of its position with respect to the second photoelectric cell 250.

In addition, the second shutter element 260 may include a membrane 262, said membrane 262 being arranged to transmit a displacement of the outer jacket 220, for example subjected to a horizontal force component, to a protrusion 261. In particular, the connection to the outer jacket 220 may be a slat that deforms according to the horizontal force exerted by the user. On this slat is rigidly attached a protrusion such as a flag which is used for measurement. Since the deformed portion is in its elastic zone, the deformation is proportional to the force.

Advantageously, the second force component will be perpendicular to the first force component.

Thus, the electronic handle 200 according to the present invention may include a sensor for deformation of the outer jacket 220, and more broadly of the handle 200, due to a horizontal component.

To this end, the second photoelectric cell 250 is preferably positioned substantially perpendicular, preferably perpendicular to the first photoelectric cell 230. More particularly, the axis of a light beam formed by the first photoelectric cell 230 is perpendicular to the light axis formed by the second photoelectric cell 250.

In one embodiment, when the electronic handle 210 includes a second photoelectric cell 250 and a second shutter element 260, one is attached to the outer jacket 220 and the other, not attached to the outer jacket 220, is attached to the central part 210.

Nevertheless, when the electronic handle 200 includes a second photoelectric cell 250 and a second shutter element 260, advantageously one is attached to the central part 210 and the other, not attached to the central part 210, is attached to a part coupled to the electronic handle. This part can, for example, correspond to a junction element between the electronic handle and a frame element.

Typically, at least one shutter element 240, 260 is attached directly or indirectly to the outer jacket 220. This attachment can be a removable or non-removable attachment. Further, in one embodiment, if a shutter element is attached to the outer jacket 220, then it will not be attached to the central part 210.

Similarly, at least one photoelectric cell 230, 250 is attached directly or indirectly to the outer jacket 220. This attachment can be a removable or non-removable attachment. In addition, if a photoelectric cell is attached to the outer jacket, then it will not be attached to the central part 210.

Advantageously, the one or more photoelectric cells 230, 250 are attached to the ends of the outer jacket 220. Preferably, they are attached to the opposite ends of the outer jacket 220. In particular, as illustrated in FIG. 9, the photoelectric cell 230 arranged for a measurement of a vertical force component F1 is preferably positioned in a proximal quartile P of the electronic handle 200 while the photoelectric cell 250 arranged for a measurement of a horizontal force component F2 is preferably positioned in a distal quartile D of the electronic handle 200. This allows an improvement in measurement accuracy and sensitivity.

Advantageously, to facilitate the horizontal displacement of the outer jacket, linear ball bearings are used, and a linear ball guide type part is used to make the connection between the central axis and the outer tube.

The outer jacket may further be covered with an ergonomic shape 221 to facilitate the grip of the electronic handle 200. The ergonomic shape 221 can be made of polymers or any other materials.

As shown in connection with FIG. 10, an electronic handle 200 according to the present invention may also be arranged to allow measurement of at least two components of a force applied thereto.

To this end, each of the electronic handles 200 advantageously includes a central part 210 comprising a first photoelectric cell 230, a first shutter element 240, a second photoelectric cell 250, and a second shutter element 260.

As already partly detailed in connection with FIGS. 1 to 9, the shutter elements 240, 260 are arranged so as to be able, depending on their position with respect to their respective photoelectric cell 230, 250, to change the amount of photons received by the receiver 232, 252.

In this embodiment, the first photoelectric cell 230 and the first shutter element 240 are arranged so that a force applied to the electronic handle 200 having a first component capable of at least partially displacing the central part 210 is capable of causing a change in the amount of photons received by the first receiver, the change being proportional to a first component of the force that has been applied to the electronic handle 200.

In addition, the second photoelectric cell 250 includes a second diode 251 capable of emitting a light beam and a second receiver 252 arranged to receive said light beam. The second photoelectric cell 250 is configured to generate a current proportional (of proportional voltage or intensity) to an amount of photons received by the second receiver 252.

The second shutter element 260 is capable, depending on its position with respect to the second photoelectric cell 250, of changing the amount of photons received by the second receiver 252.

Furthermore, the second photoelectric cell 250 and the second shutter element 260 are arranged so that a force applied to the electronic handle 200 including a second component capable of at least partially displacing the central part 210 is capable of causing a change of the amount of photons received by the second receiver 252, said change being proportional to a second component of the force that has been applied to the electronic handle 200.

It is thus possible to determine at least two components of a force applied to each of the two handles and directly causing a displacement (at least a partial deformation) of the central part 210. The two electronic handles 200 can thus be configured to control a motor fitted to the walking assistance apparatus according to the values of the two calculated force components.

As a non-limiting example, the motor control can generate a displacement of a motorized device such as a walking assistance apparatus. Such a control can be subject to the determination of the values of the two components of an applied force and calculated for the two handles, respectively.

In order to allow the independence of the measurements between the two components of a force F2 (for example horizontal) applied on each of the electronic handles 200, the latter (and in particular the position of the photoelectric cells and of the shutter elements) can be arranged in such a way that the first component of the force F2 applied to the electronic handle 200 is not capable of causing a change of the amount of photons received at the second photovoltaic cell 250, but only at the first photovoltaic cell 230.

Similarly, each of the electronic handles 200 can also be configured so that the force F1 applied to the electronic handle 200, including a second component perpendicular to the first component, is not capable of causing a change in the amount of photons received at the first photovoltaic cell 30, but only at the second photovoltaic cell 250.

In addition, the central part 210 may include an attachment region 210-1 to a motorized device such as a walking assistance apparatus according to the present invention, as well as a support region 210-2.

The attachment region 210-1 may consist of a longitudinal extension of the support region 210-2 and may include a plurality of recesses, such as a plurality of screw threads, adapted to receive attachment elements, such as by way of non-limiting examples, a plurality of screws, for connecting the electronic handle 210 to the walking assistance apparatus.

The support region 210-2 is adapted to allow a user to lean thereon when the user interacts with the motorized device or walking assistance apparatus. Thus, in this embodiment, it is the central part 210 that directly experiences a deformation when a force is applied by the user. In order to provide independent measurements in at least two dimensions, that is to say in order to measure at least two components of a force applied to the electronic handle 200 independently, the support region 210-2 of the central part 210 can advantageously comprise at least one embedded beam and a deformation bridge.

The embedded beam advantageously comprises an embedded end 211-2, 211-3 and a free end 211-1, 211-4. The embedded end 211-2, 211-3 is connected to the central part while the free end 211-1, 211-4 has a degree of freedom allowing a displacement of said free end when applying a force on the electronic handle 200. Advantageously, the embedded beams are arranged in such a way as to have a degree of freedom when a force F2 is applied along a first component, but not to have a degree of freedom when a force F2 is applied along a second component perpendicular to the first component.

As an illustrative example, the free end 211-1, 211-4 may have a degree of freedom along a specific axis such as the axis of one of the components of the applied force. This allows for a displacement of the free end 211-1, 211-4 only if the applied force has a given non-zero component. For example, the free end 211-1, 211-4 may have a degree of freedom allowing a displacement of said free end along the axis of the second component of the applied force, said second component of the applied force may correspond to a horizontal component F2. Preferably, the support region 210-2 of the central part 210 can advantageously comprise at least two embedded beams, preferably arranged at the ends, along a longitudinal axis, of the central part 210.

In addition, a deformation bridge of the central part 210 may comprise a through opening 212 opening onto a recess 213. The through opening 212 is arranged to be elastically deformable when a force is applied to the electronic handle 200. Specifically, the volume of the through opening 212 may increase or decrease as force is applied to the electronic handle 200.

By way of an illustrative example, the through opening 212 may be arranged so that its volume varies only upon the application of a force having a particular component. This allows an increase or decrease in the volume of the through opening 212, by a displacement of the central part 210 and more particularly of the support region 210-2, only if the applied force has a given non-zero component (for example a vertical component).

Thus, the increase or decrease in the volume of the through opening 212 may be generated along a specific axis of an applied force, such as the axis of one of the components of the applied force. For example, the through opening 212 may be arranged to allow a displacement of the support region 210-2, and thus an increase or decrease in the volume of the through opening 212 along the axis of the first component of the applied force, where said first component of the applied force may correspond to a vertical component F1.

Advantageously, the second photoelectric cell 250 can be attached to the central part 210, within a suitable cavity. The second shutter element 260 will be in this case attached directly to a free end 211-1, 211-4 of an embedded beam. Indeed, the application of a force on the support region 210-2, if sufficient, will induce an elastic deformation of the central part 210.

Such a deformation can be measured if the second component of the applied force is non-zero, resulting in a change of the amount of photons received by the second receiver 252. Indeed, the elastic deformation will cause a displacement of the second shutter element 260 attached to the free end 211-1, 211-4 along the axis of the second component of the applied force, thus blocking all or part of the light beam received by the receiver 252 and generated by the diode 251.

In order to measure the first component of the force applied to the support region 210-2, the first photoelectric cell 230 and the first shutter element 240 may be positioned on either side of the through opening 212 of the deformation bridge, respectively. Indeed, the application of a force on the support region 210-2, if sufficient, will induce an elastic deformation of the central part 210. Such a deformation can be measured if the first component of the applied force is non-zero, resulting in a change of the amount of photons received by the first receiver 232. Indeed, the elastic deformation will cause a displacement of the first shutter element 240 attached to the central part 210, more particularly in an adapted housing 214, along the axis of the first component of the applied force, thus blocking all or part of the light beam received by the receiver 232 and generated by the diode 231.

In order to reduce the weight of the central part 210 and to reduce the occurrence of pre-stresses at the deformation bridge, the central part 210 may include at least two central openings 216-1, 216-2 through which a portion 215 of the central part extends, said central openings being positioned between the at least one embedded beam 211-2, 211-3 and the deformation bridge.

When the central part 210 includes two embedded beams 211-2, 211-3, the two central openings 216-1, 216-2 are positioned between said embedded beams.

Such pre-stresses can generate elastic deformation of the deformation bridge and potentially a change in the amount of photons received by the first receiver 232.

As previously described, each of the electronic handles 200 may include an outer jacket 220, said outer jacket 220 being coupled and/or attached to the central part 210. Preferably, the outer jacket 220 is not attached to the central part 210, but is only coupled, for example, by one or more force transmitting elements.

To this end, one or more force transmitting elements of the outer jacket 220 are arranged so as to pass through a housing provided in the free end 211-1, 211-4 of the embedded beam 211-2, 211-3. A force transmitting element can for example correspond to a screw, a tube, a cylinder, such as a pin connecting the two parts of the outer jacket 220 and passing through the central part 210 in housings provided in the free end 211-1, 211-4 of the embedded beam 211-2, 211-3.

Preferably, in the absence of a force applied to the electronic handle, the force transmitting element is not in direct or indirect contact with the central part. Preferably, the housing provided in the free end 211-1, 211-4 of the embedded beam 211-2, 211-3 has a member, such as a pin, with a clearance fit. The outer jacket 220 preferably transmits external forces to the central part 210 through the pins passing through the central part in its parts 211-1 and 211-4, having a clearance fit. In particular, the pins may correspond to metal cylinders passing through the central part 210 at the free end 211-1 and 211-4 and being accommodated in the outer part 220. These pins are advantageously mounted with a clearance so that they can rotate freely, thus only transmitting forces from the outer part to the central part.

Such a force transmitting element avoids torsional forces that can interfere with measurements when a force is applied by a user. Thus, such an arrangement allows to improve the accuracy of the measurement and in particular its linearity.

The handle may also include an attachment element such as a screw passing through the central part 210 into the central openings 216-1 and 216-2.

Thus, the force applied by a hand on the handle can be modeled by a force, F, in the sagittal plane, having a vertical component, F1, and a horizontal component, F2, in the users walking direction. Such an electronic handle allows the user to bypass the compressions made by the user when using the handle and focus on actions involving a force associated with a given direction.

As mentioned, a motorized walker 1 according to the invention is configured so that it can be intuitively controlled by a user. In particular, a motorized walker 1 according to the invention is configured such that at least one displacement motor 20 and at least one verticalization motor 30 can be controlled by a user from a manipulation of the electronic handles.

Thus, at least one of the electronic handles 200 includes a sensor coupled, preferably operatively coupled, to a control module 40, and the control module 40 is configured to be able to control the verticalization motor 30 and the traveling motor 20. In particular, and as illustrated in FIG. 11, the control module 40 will be able to control the verticalization motor 30 and the traveling motor 20 according to values transmitted by the sensor of the electronic handle. In addition, the electronic handle 200 may include a plurality of sensors coupled, preferably operatively coupled, to the control module 40.

The coupling allows the sensor to transmit data to the control module. The operative coupling of one or more sensors of one of the electronic handles 200 to the control module may correspond to a transmission of information, such as current values (intensity or voltage) from the sensors to the control module, this directly or indirectly. In addition, this operative coupling can include a fusion of information from the sensors so that the control module can instruct one or more motors based on values from multiple sensors. Such a sensor fusion allows, for example, to detect the users intention to stand up in order to synchronize the movement of the walker with the human's movement.

Because the electronic handle 200 has sensors and electronics, it is necessary to run cables from the electronics location on the frame. The cables are for example integrated in a cylinder of a verticalization ramp. To this end, a cable carrier chain is placed inside the cylinder tube. This solution allows the complete integration of the cables inside the mechanism and protects the cables from the rotating screw and the passage of the nut and the external guide. The cable carrier chain allows the circulation of a 5-wire cable with a pitch of 0.8 mm from the handle attachment to the location of the system's control electronics.

Preferably, the sensor of the electronic handle 200 is arranged so as to measure at least one component of a force applied to the electronic handle 200.

The sensor of the electronic handle 200 may be any device arranged and configured to measure the value of a force or effort. For example, a sensor of the electronic handle 200 may be selected from: a force sensor, a pressure sensor, a barrier photoelectric cell, a displacement sensor. In particular, the sensor in the electronic handle 200 may include a strain gauge, a resistive force sensor, or a photoelectric cell. Preferably, the electronic handle 200 according to the invention includes a first photoelectric cell 230.

In particular, the control module 40 may include one or more processors 41.

The control module 40 can advantageously be configured to cooperate with the sensors, collect the data measured by said sensors, and calculate a value from said measured data. Such cooperation can take the form of an internal communication bus.

Preferably, the control module 40 is configured to further calculate a force variation value applied to the electronic handle over a time interval and to initiate movement of the electronic handles when the calculated applied force variation value is greater than a predetermined force variation value. Thus, the motorized walker 1 can carry out a verticalization adapted to the individual at a time wished by the individual without him/her having to carry out another action than to lean on the electronic handles when he/she wishes to stand up by leaning on a table, for example.

Preferably, the control module 40 is configured to further calculate a force value applied to the electronic handle 200 and to initiate verticalization only if the calculated force value applied to the electronic handle at the beginning of the time interval is lower than or equal to a predetermined force value.

Preferably, the control module 40 is further configured to control the at least one verticalization motor 30 so as to minimize jerk during ascent, and preferably to control the position of the electronic handles 200 during ascent so that their position X(t) satisfies the following equation:

$$X ( t ) = {X}_{i} + ( {X}_{f} - {X}_{i} ) ⋆ [ 10 ⋆ {( \frac{t}{T} )}^{3} - 15 ⋆ {( \frac{t}{T} )}^{4} + 6 ⋆ {( \frac{t}{T} )}^{5} ] \qquad [ Math 1 ]$$

Where:
X(t) is the position of the electronic handle, on a vertical axis, with respect to a lowest position Xi, as a function of time t;
Xf is a maximum height of the electronic handle, and
T is a total verticalization time.

Hogan N (1984) Adaptive control of mechanical impedance by coactivation of antagonist muscles. IEEE Trans. Automatic. Control AC-29: 681-690

In addition, when a motorized walker 1 according to the invention is equipped with a proximity sensor 50, then the processor 41 is advantageously configured to initiate verticalization when the measured proximity value is greater than a predetermined proximity value.

In addition, the control module 40 may include a data memory 42. Advantageously, the data memory 42 may comprise a non-erasable section, physically isolated or simply arranged so that write or erase access is prohibited. The data memory can further be arranged to store data measured by the sensors present on a motorized walker. The data memory 42 may further include one or more programs, or more generally one or more sets of program instructions, said program instructions being intelligible to the processor 41. The execution or interpretation of said instructions by said processor causes the implementation of a method for controlling a motorized walker 1 according to the invention.

Preferably, the data memory 42 is configured to store a minimum and maximum height of the electronic handles on each of the verticalization ramps 100.

The minimum height is preferably between 400 cm and 600 cm from the ground and the maximum height is preferably between 900 cm and 1100 cm from the ground.

The data memory 42 is advantageously configured to store threshold values that can be used when controlling the motorized walker 1 by a processor 41 or more generally by a control module 40. For example, a predetermined threshold value of an applied force, a predetermined threshold value of an applied force variation, and/or a predetermined threshold value of proximity.

The data memory 42 may further be configured to store a verticalization time.

In addition, the control module 40 may include a communication module 43 providing communication between the various components of the control module 40, in particular according to a suitable wired or wireless communication bus.

Preferably, the communication module 43 is configured to provide communication of data measured by the sensors of a motorized walker according to the invention to a data memory configured to store such data. In addition, the communication module also allows communication between the processor and the data memory, in particular to calculate a value according to the stored data, which value can then be stored directly in a suitable field in the data memory. Finally, the communication module also allows the processor to control a verticalization motor and a traveling motor of a motorized walker, in particular a control of either motor can be associated with a value calculated from the data measured by the sensors.

In particular, each of the verticalization ramps 100 includes a cable carrier chain allowing a direct or indirect wire connection to be established between at least one of the electronic handles and the verticalization motor and/or the traveling motor.

In addition, the control module 40 may include a Human-Machine Interface 44.

The latter can advantageously be arranged to cooperate with a processor, the human-machine interface can correspond to a screen, a printer, a communication port coupled to a computer device or any other interface allowing to communicate with a human, in a perceptible way via one of his/her senses or a computer client via a communication link. Such an HMI can be used to configure the control module. In particular, the control module can interact via an HMI with other electronic devices or connected objects in order to collect settings data. Such parameter data can, for example, correspond to maximum and/or minimum height values.

Alternatively, a control at the electronic handles can be used to store the minimum and/or maximum height information, for example on first use.

Advantageously, the HMI and especially the electronic handles in connection with the control module are configured to detect the users intention (to stand up or to sit down) and whether the user is still in connection with the sit-to-stand device (if, for example, there was a false start and the user did not stand up).

Furthermore, a motorized walker 1 according to the invention is equipped with a suitable power source (not shown in the figures) allowing the various elements of said motorized walker to operate. Such a power source generally consists of a battery or a plurality of batteries arranged to deliver sufficient electrical energy to enable the operation of the various verticalization and traveling motors or to ensure the operation of the various components of the control module.

A motorized walker 1 according to the invention cannot be limited to a single control module 40, it is provided, in a particular embodiment, that the motorized walker 1 includes a dedicated control module for each handle. Each of the control modules can thus be arranged inside or outside the handle with which it is associated. In addition, the walker may include a motor power electronics board that controls the power sent to said motor.

According to another aspect, the invention relates to a method 300 for controlling a motorized walker 1, preferably a motorized walker 1 according to the invention.

A control method 300 according to the invention is particularly suitable for a motorized walker 1 comprising:
at least one wheel coupled to a traveling motor 20;
two verticalization ramps 100, each of said verticalization ramps 100 being associated with an electronic handle 200 that is movable in translation along the verticalization ramp 100 with which it is associated;
at least one verticalization motor 30 arranged to allow a movement, preferably a synchronous movement, of the electronic handles 200 along the verticalization ramps 100;

at least one of the electronic handles 200 including a sensor operatively coupled to a control module 40,

said control module 40 being configured to control the verticalization motor 30 and the traveling motor 20.

A control method 300 according to one embodiment of the invention is illustrated in FIG. 12. As illustrated, a method of controlling 300 a motorized walker 1 includes the steps of measuring 320 at least one force value applied to an electronic handle 200, comparing 330 the at least one applied force value to a predetermined threshold force value, and generating 370 a control command to at least one of the verticalization and traveling motors.

In addition, a method of controlling 300 a motorized walker 1 may include the steps of calibrating 310 the motorized walker, calculating 340 a time variation value of a force applied to an electronic handle 200, comparing 350 the time variation value of an applied force to a predetermined threshold value, and determining 360 a position value of the at least one electronic handle 200.

Thus, as illustrated in FIG. 12, a method of controlling 300 a motorized walker 1 may include a step of calibrating 310 the motorized walker 1. Indeed, a control method is advantageously adapted to the user of the motorized walker 1. Thus, it will be advantageous, for example during a first use, to calibrate the motorized walker 1 and to adapt its operation to the physiognomy and physiology of a given user. In particular, the calibration step 310 may include storing, for example on a data memory 42:
a lowest position value Xi, for example on a vertical axis, of one or two electronic handles 200;
a maximum height value Xf of one or two electronic handles, and/or
a value for the total verticalization time T.

Storing such data allows on, the one hand, to adapt the operation of the walker to the physiognomy of a given user (for example handle heights), but also to adapt it to his/her physiology (for example total verticalization time).

In addition, the calibration step 310 may include storing, for example on a data memory 42:
a predetermined threshold value of an applied force,
a predetermined threshold value of an applied force variation, and/or
a predetermined proximity threshold value.

Alternatively, these threshold values may have been pre-stored in a data memory 42 when the motorized walker 1 was designed.

A method of controlling 300 a motorized walker includes a step of measuring 320 at least one force value applied to an electronic handle 200. This measurement step 320 may correspond to generating a value of a component of a force applied to the electronic handle 200 by a user. Preferably, the applied force, the value of which is measured, corresponds to a vertical component of the applied force. Thus, the detection of the sit-to-stand transfer movement is at least partially done by measuring the vertical bearing force on the electronic handles 200. Advantageously, this step may include measuring 320 at least two components of the force applied to the electronic handle 200. Furthermore, this measurement 320 can preferably be performed for both electronic handles 200.

This step can be performed by one or more sensors of an electronic handle 200.

A method of controlling 300 a motorized walker includes a step of comparing 330 the at least one applied force value to a predetermined applied force threshold value. Such a comparison allows to generate an indicator of the users posture. For example, the comparison step can lead to the generation of a binary value (for example yes/no).

Indeed, a method according to the invention can advantageously detect a users posture and in particular his/her ability or need to move from the sitting to the standing position by detecting that a threshold value is exceeded by a measured value of an applied force. This comparison step may also involve generating a posture indicator in the form of an alphanumeric value or a numeric value. A numeric value may, for example, correspond to a difference between the measured value and the predetermined threshold value. A posture indicator value can advantageously be used in combination with other values when generating a control instruction.

This step can be performed by a control module 40 and in particular by a processor 41 configured to perform such a comparison and generate the users posture indicator.

As illustrated in FIG. 12, a method of controlling 300 a motorized walker 1 may advantageously include a step of calculating 340 a value of a variation over time of a force applied to an electronic handle 200.

This step may be performed by a control module 40 of a motorized walker 1 and more particularly by a processor 41 of said control module 40.

In particular, such a time variation value may correspond to a force variation applied during a predetermined time interval. The time interval is preferably less than 1 second, more preferably less than 0.5 seconds, even more preferably less than 0.2 seconds.

Thus, the method according to the invention allows for real-time monitoring of a users interactions with a motorized walker to determine intent. This value can be calculated for one electronic handle 200 and preferably for both electronic handles 200. Advantageously, the applied force, the time variation of which is calculated, corresponds to a vertical component of the applied force.

This calculated value can be used in a step 350 of comparing the time variation value of an applied force to a predetermined threshold value of an applied force variation.

Such a comparison allows to generate an indicator of a users intention. For example, the comparison step can lead to the generation of a binary value (for example yes/no). In particular, such an intention index can correspond to a posture transition intention indicator. This comparison step may also involve generating an intent indicator in the form of an alphanumeric value or a numeric value. A numeric value may, for example, correspond to a difference between the calculated value and the predetermined threshold value. An intent indicator value can advantageously be used in combination with other values when generating a control instruction.

Thus, the method according to the invention will advantageously be able to best characterize a users intention to move from a sitting to standing position. In particular, it has been shown that the joint use of a detection threshold based on a value of an applied force, preferably a value of a vertical component, coupled with a detection threshold based on a value of a variation of an applied force, allows for better control results and an increase of the specificity of the control.

As illustrated in FIG. 12, a method for controlling 300 a motorized walker may also include a step of determining 360 a position value of the at least one electronic handle 200. For example, a position sensor, preferably positioned at a verticalization ramp 100 or an electronic handle 200, may be configured to determine the position of the handle. This position value of the electronic handle can advantageously be used in combination with other values when generating a control command.

This step can be performed by a control module 40 and more particularly a processor 41 configured to determine such a position value from the data provided by a suitable sensor.

In addition, a method of controlling 300 a motorized walker may also include a step of determining a proximity value between the trunk of a user of the motorized walker 1 and a proximity sensor 50.

For example, a proximity sensor may determine the distance between the user and said proximity sensor. This distance value or an index of the users position derived from such a distance value can advantageously be used in combination with other values when generating a control instruction.

This step can be performed by a control module 40 and more particularly a processor 41 configured to determine the distance separating a user from a proximity sensor positioned on the motorized walker 1, from the data provided by said proximity sensor.

In addition, a method of controlling 300 a motorized walker may also include a step of generating 370 a control command to at least one of the verticalization motor 30 and the traveling motor 20. As discussed, this control instruction generation step can be performed based on the measured value of force applied to an electronic handle or on a posture index value. In particular, the control instruction may be a function of the comparison of at least one applied force value with a predetermined applied force threshold value.

Advantageously, the generation 370 of a control instruction can also take into account other parameters. Preferably, it takes into account the measured value of force applied to an electronic handle or the posture index value in combination with the value of time variation of a force applied to an electronic handle or the intention index value.

In addition, the generation 370 of a control instruction may also take into account the position index value or the measured distance value of the user from the proximity sensor.

This step may be performed by a control module 40 of a motorized walker 1 and more particularly by a processor 41 of said control module.

Advantageously, based on neuroscience concepts, the present invention proposes that the control instruction be generated in such a way as to minimize jerk associated with verticalization. In particular, the generated control instruction is such that it allows to determine verticalization kinetics which satisfy the following equation:

$$X ( t ) = {X}_{i} + ( {X}_{f} - {X}_{i} ) ⋆ [ 10 ⋆ {( \frac{t}{T} )}^{3} - 15 ⋆ {( \frac{t}{T} )}^{4} + 6 ⋆ {( \frac{t}{T} )}^{5} ]$$

Where:
X(t) is the position of the electronic handle, on a vertical axis, with respect to a lowest position Xi, as a function of time t;
Xf is a maximum height of the electronic handle, and
T is a total verticalization time.

The steps of the method have been described in particular in connection with verticalization and thus the generation of a control command to at least one verticalization motor 30.

Nevertheless, the present control method 300 advantageously generates 470 a control instruction to at least one traveling motor 20 and/or verticalization motor 30.

Thus, preferably, a method according to the invention includes a measurement 420 of at least one horizontal component value of the force applied to an electronic handle 200.

This measurement step 420 may correspond to generating a value of a horizontal component of a force applied to the electronic handle 200 by a user. Herein, the detection of a given users intent to move the walker forward is at least partially done by measuring the horizontal bearing force on one or two electronic handles 200. Advantageously, this step may involve measuring at least two components of the force applied to the electronic handle 200. Furthermore, this measurement 420 can preferably be performed for both electronic handles 200.

A method of controlling 300 a motorized walker may then include a step of comparing 430 the at least one horizontal component value of the force applied to an electronic handle to a predetermined threshold value of an applied force. Such a comparison allows to generate a users displacement indicator. For example, the comparison step can lead to the generation of a binary value (for example yes/no).

Indeed, the method according to the invention will advantageously be able to detect a movement initiated by a user and in particular his/her intention to move the motorized walker 1 forward by detecting that a threshold value is exceeded by a measured value of an applied force.

This comparison step may involve generating a displacement indicator in the form of an alphanumeric value or a numeric value. A numeric value may, for example, correspond to a difference between the measured value and the predetermined threshold value. A displacement indicator value can advantageously be used in combination with other values when generating a control instruction.

This comparison step 430 may be performed by a control module 40, and more particularly a processor 41 configured to determine an indicator of the users displacement, from one or more values of one or more components of the force applied to an electronic handle 200 measured by a sensor arranged in said handle.

As illustrated in FIG. 13, a method of controlling 300 a motorized walker may advantageously include a step of calculating 440 a time variation value of a horizontal component of force applied to an electronic handle 200.

In particular, such a time variation value may correspond to a variation of the applied force during a predetermined time interval. The time interval is preferably less than 1 second, more preferably less than 0.5 seconds, even more preferably less than 0.2 seconds. Like the step of calculating 340 a time variation value of a force applied to an electronic handle 200, said calculating step 440 may be performed by a control module 40 of a motorized walker 1, and more particularly by a processor 41 of said control module.

This calculated value can be used in a step of comparing 450 the time variation value of an applied horizontal force component to a predetermined threshold value of a variation of an applied horizontal force component.

Such a comparison allows to generate a users speed indicator. For example, the comparison step can lead to the generation of a binary value (for example yes/no). In particular, such a speed index can correspond to a speed intention. This comparison step may also involve generating a speed indicator in the form of an alphanumeric value or a numeric value. A numeric value may, for example, correspond to a difference between the calculated value and the predetermined threshold value. A speed indicator value can advantageously be used in combination with other values when generating a control instruction.

Thus, the method according to the invention will advantageously be able to best characterize the intention of a user to move by means of the motorized walker 1.

In order to further customize the behavior of the walker, some parameters of the walker such as the maximum height of the electronic handles, the speed of verticalization, or the threshold to initiate verticalization or to return to the low position can be adapted by learning. Learning can be supervised or unsupervised. The walker is able to implement algorithms based on supervised or unsupervised learning methods. Thus, advantageously, the walker is configured to train and implement one or more algorithms. These algorithms may have been built from different learning models, in particular partitioning, supervised, or unsupervised models. The algorithm can be derived from the use of a supervised statistical learning model selected, for example, among the kernel methods (for example Support Vector Machines SVM, Kernel Ridge Regression) described for example in Burges, 1998 (Data Mining and Knowledge Discovery. A Tutorial on Support Vector Machines for Pattern Recognition), set methods (for example decision trees) described, for example, in Brieman, 2001 (Machine Learning. Random Forests), k-means partitioning, decision trees, logical regression or neural networks described, for example, in Rosenblatt, 1958 (The perceptron: a probabilistic model for information storage and organization in the brain).

In addition, a method of controlling a motorized walker may also include a step of generating 470 a control command to at least one movement motor 20. As discussed, this control command generation step can be performed based on the measured value of the horizontal component of force applied to an electronic handle or on a displacement index value. In particular, the control instruction may be a function of the comparison of at least one applied force value with a predetermined applied force threshold value.

Advantageously, the generation 470 of a control instruction can also take into account other parameters. Preferably, it takes into account the measured value of the horizontal component of force applied to an electronic handle or the value of displacement index in combination with the time variation value of the horizontal component of a force applied to an electronic handle or the speed index value. Advantageously, the control instruction can also be generated so as to minimize jerk associated with the movement of the motorized walker 1.

Thus, a motorized walker 1 according to the invention or a control method 300 according to the invention allow intuitive control of a walker by a user generally in a situation of motor deficiency on his/her lower limbs. In particular, by means of the electronic handles alone, a user will be able to both control the verticalization means (that is to say ramp) 30 (that is to say verticalization motor) to help him/her move from a sitting to a standing position, and control the traveling means 20 (that is to say the traveling motor) of the motorized walker after it has helped him/her move to the standing position.

1. A motorized walker comprising a frame having a front portion and a rear portion, a pair of wheels being arranged to support the rear portion of the frame, and at least one wheel being arranged to support the front portion of the frame, at least one of the wheels being coupled to a traveling motor, wherein:
the frame is equipped with two verticalization ramps, said verticalization ramps each having a longitudinal axis forming an angle with an axis perpendicular to the ground between 20° and 40°, each of said verticalization ramps being associated with an electronic handle movable in translation along the verticalization ramp to which it is associated,
at least one verticalization motor arranged to allow a synchronous movement of the electronic handles along the verticalization ramps, said movement being capable of moving a user of the walker from a sitting position to a standing position,
at least one of the electronic handles comprising at least two sensors operatively coupled to a control module, one of said sensors being configured to measure a horizontal component and the other of said sensors being configured to measure a vertical component of a force applied to said at least one electronic handle by the user, said control module being configured to be able to control the at least one verticalization motor and the traveling motor, and
the at least one verticalization motor and the traveling motor being controlled according to values transmitted by the sensors of the at least one of the electronic handles, the control module being configured to calculate an intention index and a displacement indicator of a user of the walker corresponding to an interaction of the user with the walker, the intention index being partly calculated from a value of the vertical component and the displacement indicator, at least in part, from a value of the horizontal component of the applied force.

2. (canceled)

3. The motorized walker according to claim 1, wherein the calculation of the intention index of a user of the walker further uses a prediction model trained from data generated by the sensors of the at least one of the electronic handles, during use of the motorized walker by said user.

4. The motorized walker according to claim 1, wherein the control module is configured to further determine when a user of the walker is seated and the user is not leaning on the walker, in particular from a prediction model trained from data generated by the sensors of the electronic handles, during use of the motorized walker by said user.

5. (canceled)

6. The motorized walker according to claim 1, wherein each of the verticalization ramps comprises a motorized screw-nut system driven by the at least one verticalization motor allowing the electronic handles to move along the verticalization ramps.

7. The motorized walker according to claim 1, wherein the verticalization ramps comprise a bearing located opposite the at least one verticalization motor with respect to a screw-nut system.

8. The motorized walker according to claim 1, wherein the electronic handles and the verticalization ramps are coupled via an internal guide system, said internal guide system being positioned inside the verticalization ramps.

9. The motorized walker according to claim 1, wherein the electronic handles and the verticalization ramps are coupled via an external guide system, said external guide system being positioned outside the verticalization ramps.

10. The motorized walker according to claim 1, wherein it comprises two verticalization motors, each coupled to one of the verticalization ramps and preferably positioned at one end of the verticalization ramp.

11. The motorized walker according to claim 1, further comprising a data memory, said data memory being configured to store a maximum height of the handles on each of the verticalization ramps, said maximum height of the electronic handles having been calculated from a prediction model and data generated by the sensors of the at least one of the electronic handles.

12. The motorized walker according to claim 1, further comprising a data memory, said data memory being configured to store a minimum height and a maximum height of the electronic handles on each of the verticalization ramps.

13. The motorized walker according to claim 1, wherein the sensors are selected from: a force sensor, a pressure sensor, a photoelectric barrier cell, a displacement sensor.

14. (canceled)

15. The motorized walker according to claim 1, wherein the control module is configured to further calculate a force variation value applied to a said electronic handle over a time interval and to initiate movement of the electronic handles when the calculated applied force variation value is greater than a predetermined force variation value.

16. The motorized walker according to claim 1, wherein the control module is configured to further calculate a force value applied to a said electronic handle and to initiate verticalization only if the force value applied to said electronic handle is greater than or equal to a predetermined force value.

17. The motorized walker according to claim 1, further comprising a proximity sensor configured to measure a proximity value between a trunk of the user of the walker and the frame, the control module being further configured to initiate verticalization when the measured proximity value is greater than a predetermined proximity value.

18. The motorized walker according to claim 1, wherein the control module is further configured to control said at least one verticalization motor so as to minimize jerk during ascent, and to control a position of the electronic handles during ascent so that their position X(t) satisfies the following equation:
$$X ( t ) = {X}_{i} + ( {X}_{f} - {X}_{i} ) ⋆ [ 10 ⋆ {( \frac{t}{T} )}^{3} - 15 ⋆ {( \frac{t}{T} )}^{4} + 6 ⋆ {( \frac{t}{T} )}^{5} ]$$
Where:
X(t) is the position of the electronic handles, on a vertical axis, with respect to a lowest position Xi, as a function of time t;
Xf is a maximum height of the electronic handles, and
T is a total verticalization time.

19. A method for controlling a motorized walker according to claim 1, said control method comprising the following steps:
Measuring, by the sensors of at least one electronic handle, at least one force value applied to the at least one electronic handle,
Comparing, by a control module, the at least one force value applied to a predetermined threshold value of an applied force, and
Generating, by the control module, a control command to at least one of the verticalization and traveling motors according to the determined position of the at least one electronic handle and the measured applied force value.

20. The motorized walker according to claim 1, wherein the control module is configured to further determine whether a user of the walker is standing while leaning on the walker from data generated by the sensors of the electronic handles.
